(19) United States
(12) Patent Application Publication
(10) Pub. No.: US 2018/0349893 A1
(43) Pub. Date: Dec. 6, 2018

(54) SYSTEM FOR OUTPUTTING PRODUCT TRACEABILITY CODE

(71) Applicant: Cheng-Yu TSAI, Taipei City (TW)

(72) Inventor: Cheng-Yu TSAI, Taipei City (TW)

(21) Appl. No.: 15/985,715

(22) Filed: May 22, 2018

(30) Foreign Application Priority Data
Jun. 3, 2017 (TW) 106118416

(51) Int. Cl. G06Q 20/38; H04L 9/06; H04L 29/08; G06K 19/06; G06T 19/00

(52) U.S. Cl. CPC G06Q 20/3821; G06Q 20/388; H04L 9/0637; G06Q 2220/00; G06K 19/06037; G06T 19/006; H04L 67/104

(57) ABSTRACT

A system for outputting a product traceability code is disclosed. In the system, an initialization module can create a non-deletable and non-modifiable storage space corresponding to a physical product, a generation module can generate and output the product traceability code according to the URI. During the transaction for the product, according to the URI obtained by scanning or sensing the product traceability code, the user can link to the storage space to store and browse a transaction message of the product. As a result, the system of the present invention can improve authentic and fake identification and transaction transparency of the physical product.

### CROSS-REFERENCE TO RELATED APPLICATION

The application is a counterpart foreign application of TAIWAN Patent Application Serial Number 106118416, filed on Jun. 3, 2017, the disclosure of which is hereby incorporated by reference in its entirety.

### BACKGROUND

### Technical Field

The present invention generally relates to an output system, more particularly to a system for outputting a product traceability code, and the system uses an output device to integrally combine the product traceability code with a product permanently, so that the product traceability code can be scanned or sensed during the transaction for the product, thereby storing a transaction message.

### Description of Related Arts

In recent years, with the popularization and rapid development of e-commerce, various transaction models are developed, such as Business to Business (B2B), Business to Consumer (B2C), Consumer to Consumer (C2C), Consumer to Business (C2B), Online to Offline (O2O), and so on. In each of transaction models, how to provide a reference for determining authenticity of the to-be-traded target, which may also be referred to as physical object, physical goods or physical product, and how to prevent cooperating manufacturers from producing and selling more than authorized quantities of physical products to infringe the rights of both the creators and the buyers, are key issues for the creators.

In general, there is technical solutions using various digital processing technologies for determining authenticity of digital content, for example, the digital processing technologies including voucher signature, algorithm encryption, digital watermark and so on, can effectively prevent digital contents from being forged or tampered. For example, U.S. patent application publication No. US 2016/0323109 discloses a method for transferring rights of digital contents using a blockchain which is hard to be tampered and is decentralized stored, and the transaction history can be recorded in the blockchain, so that each transaction can be tracked, thereby protecting rights of the creators and owners of the digital contents. However, these digital processing technologies cannot be directly applied to the physical product to be traded. The digital content can be directly processed by the digital processing technology, but the physical product cannot be directly processed by the digital processing technology, so that the buyer only can depend on experience thereof or an appraiser's experience, to determine the authenticity of the physical product to be traded. The conventional authentication methods for physical products may include production and sales traceability, food traceability, or retrospection barcode. In these methods, a barcode or a sticker is attached to the physical product, so that the buyer can sense or scan the barcode or sticker to query and identify description of the physical product, from a database. These methods may implement a combination of virtual data (such as digital data) and real object (such as physical product). However, using the barcode or sticker cannot effectively solve the problem that the product attached with the barcode or sticker may be a counterfeit product or an unauthorized product, so these conventional methods are unable to perform the authentication effectively. Obviously, the root cause of the above-mentioned problem is that the virtual data and physical product are not combined tightly and inseparably.

In order to solve the problem, some manufacturers propose to use the augmented reality (AR) technology to tightly combine virtual data and physical product. For example, U.S. Pat. No. 9,038,127 discloses physical interaction with virtual objects for digital rights management (DRM). The system provided by this patent comprises an image generation unit for displaying an image of a virtual object representing a digital content item in a user field of view of an augmented reality display; a sensor to sense physical actions of the user; a software controlled processor to indicate a transfer request of a right to the digital content item according to physical actions; and, a memory accessible by the processors for storing transfer rules for the digital content item. The processor can determine whether to transfer the right to the digital content item based on the transfer rules for the digital content item. As a result, the system of this patent can transfer the right and create a corresponding relationship between the image of virtual object and the physical action. However, since the technical solution provided by this patent is only used for digital rights management, and does not disclose how to process the physical product with the digital data to make the combination between the virtual data and the physical product inseparably; furthermore, this patent also does not disclose any technical solution for identifying authenticity of the physical product.

Furthermore, U.S. Pat. No. 9,007,364 discloses an augmented reality device using database to record data, and a method thereof. After the record data is received, a virtual image and record data both can be displayed on the display device. This technical solution can be applied to customer relationship management (CRM), and the user can directly communicate with the person associated with the record data. For example, when the user scans a physical object, such as a business card, the augmented reality display device can display a virtual business card image, and also display the record data in a corresponding position on the virtual business card image; for example, the record data can be a name, a telephone number, an address or an email, and the user can communicate directly with the owner of the business card via email. However, the technical solution provided by this patent only displays the combination of the virtual images and the record data, and is not applied to transaction, so this patent does not disclose the right transfer of the transaction, how to prevent the record data from being tampered, how to improve transparency of transaction, and how to achieve the purpose of determining the authenticity of the physical product according to the transaction transparency.

Furthermore, U.S. Pat. No. 8,910,243 discloses a method for controlling image display on a remote controller based on augmented reality. In this method, a real picture of the user's surrounding environment is captured by a camera with an identification unit, and the identification unit can identify the electronic device having a playable content in the real picture, and a wireless communication module is used to receive the information about the locked status of the playable content of the identified electronic device, so as to indicate the locked status of the object displayed on the screen. When the playable content of the identified electronic device requires the user to authenticate for playing the content, the object and the real picture both are displayed on the screen, and after the authentication entered by the user is confirmed to match with the authentication stored in advance, the playable content can be released from the locked status and displayed on the screen. This method uses radio frequency identification (RFID) technology or the camera with the identification unit to identify the object around the user, such as the electronic device having playable content, but this patent does not disclose the technical solution of providing the user to identify authenticity of the object and increasing transaction transparency.

Furthermore, U.S. Pat. No. 8,793,770 discloses a method and device for authorizing use of augmented reality (AR) information. The method includes steps of: acquiring location information regarding a location at which the AR information is to be provided; creating authorization information comprising a service identifier of a user authorized to use the AR information; creating attribute information comprising the AR information, the location information, and the authorization information for the AR information; and transmitting the attribute information to an AR system to request the AR system to register the attribute information. Through these steps, the augmented reality information can be authorized to the user for use. However, this method is applied for the geographic location of the physical space, but not for a single physical product and not involve any transaction means. Therefore, this patent does not disclose how to process the identifier and the physical product to integrally combine them permanently, so as to facilitate to use the identifier to query a transaction history of the physical product as a reference for determining authenticity of the physical object.

Therefore, what is needed is to develop an improved technical solution to solve the conventional problem that the authentic and fake identification and transaction transparency for physical product is poor.

### SUMMARY

In order to solve the conventional problems, the present invention is to provide a system for outputting a product traceability code.

According to an embodiment, the present invention provides a system for outputting product traceability code, and the system comprises an initialization module and a generation module. The initialization module is configured to create a genesis block corresponding to a product, and use the genesis block as a header of a blockchain, and also create a smart contract in the genesis block. The smart contract comprises a URI, a creator contact message, an owner account address, and a transaction function which all correspond to the product. During a transaction for the product, a blockchain node comprising the owner account address is permitted, according to the smart contract, to call the transaction function to set the owner account address as a seller account address and store the seller account address, the buyer account address, a transaction amount and a transaction time in a transaction array, and set the buyer account address as the owner account address. According to the creator contact message, the owner terminal can transmit the transaction message comprising the seller account address, the buyer account address, transaction amount and transaction time, for display. The generation module is configured to generate and output a product traceability code, according to the URI and an address of the smart contract in the blockchain.

According to another embodiment, the present invention provides a system for outputting a product traceability code, and the system comprises an initialization module and a generation module. The initialization module is configured to set up a storage space corresponding to a product. The storage space is accessible, non-deletable and non-modifiable, and configured to store a URI, a creator contact message, an owner account and a transaction array which all are associated to the product, in advance. During the transaction for the product, an owner terminal having the owner account is permitted to set the owner account as a seller account and store the seller account, the buyer account, a transaction amount and a transaction time in the transaction array, and set the buyer account as the owner account. According to the creator contact message, the owner terminal can transmit the transaction message including the seller account, the buyer account, the transaction amount and the transaction time, for display. The generation module is configured to generate and output a product traceability code according to the URI.

According to above content, the difference between the system of the present invention and the conventional technology is that the system of the present invention can use the initialization module to set up the non-deletable and non-modifiable storage space corresponding to the product, and use the generation module to generate the product traceability code according to the URI, and use the combination module to integrally combine the product traceability code and the product permanently, through the output device. During the transaction for the product, the user can link to the storage space to store and browse the transaction message of the product, according to the URI obtained by scanning or sensing the product traceability code.

Therefore, the technical solution of the present invention can improve authentic and fake recognition and transaction transparency of the product.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a system for outputting a product traceability code, according to an embodiment of the present invention.

FIG. 2 is a flow chart of a method of outputting a product traceability code, according to an embodiment of the present invention.

FIG. 3 is a schematic view of operations of creating a smart contract and generating a product traceability code, according to an embodiment of the present invention.

FIG. 4 is another schematic view of operation of generating a product traceability code, according to another embodiment of the present invention.

FIG. 5 is a schematic view of transaction data stored in the transaction array, according to an embodiment of the present invention.

FIG. 6 is a schematic view of a marking array, according to an embodiment of the present invention.

FIG. 7 is a schematic view of operation of displaying the marking by an augmented reality manner, according to an embodiment of the present invention.

FIG. 8 is another block diagram of a system for outputting a product traceability code, according to another embodiment of the present invention.

FIG. 9 is a flow chart of a method of outputting a product traceability code, according to another embodiment of the present invention.

FIG. 10 is a schematic view of the AR marking, according to an embodiment of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be understood that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be understood to imply the inclusion of stated elements but not the exclusion of any other elements.

The environment where the system of the present invention is applied is described before the illustration for the system for outputting a product traceability code of the present invention. The system of the present invention can be applied to a computing device which is able to execute program instructions, and this computing device is electrically connected to a plurality of nodes (that is, blockchain nodes) forming a blockchain network; furthermore, the computing device may also be regarded as a node of the blockchain network. The nodes have blockchains with contents the same with each other, and the content of each blockchain includes a smart contract, created by the computing device, and all transaction records. In actual implementation, the smart contract can be a computer program including variable statuses and functions, and the computer program can be written in a programming language such as Solidity, Serpent, LLL, EtherScript, Sidechain and so on. For example, for a blockchain program Ethereum, the smart contract is a binary code and an application binary interface (ABI) after the source code of the smart contract written in the programming language is compiled, so as to broadcast the smart contract to the blockchain network and wait for a miner to add the smart contract into the blockchain, thereby obtaining an address (that is, an address of smart contract). Next, the smart contract can be executed according to the address, and the status of the smart contract in the blockchain can be changed by using different instructions. Preferably, the node can be a computing device such as a personal computer, a notebook computer, a server, a tablet computer, a smartphone, and so on, and the nodes are electrically linked to each other by a peer to peer manner, to execute the computer program instructions, such as the blockchain program Ethereum.

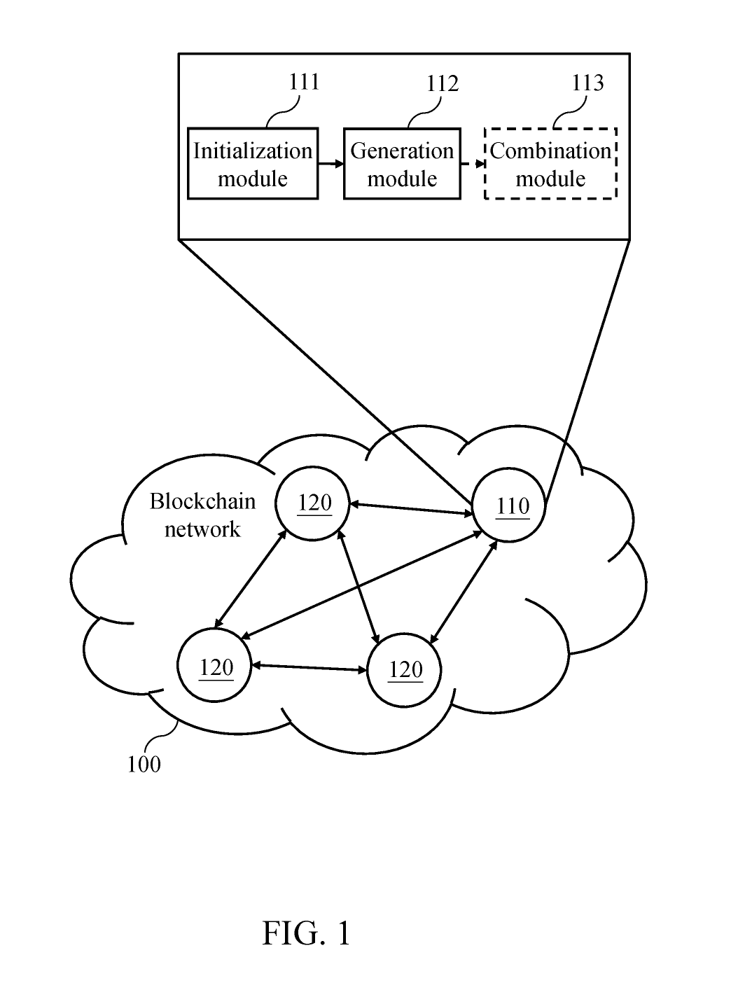

The system for an outputting product traceability code, according to an embodiment of the present invention, will hereinafter be described in more detail, with reference to the accompanying drawings. Please refer to FIG. 1, which is a block diagram of the system for outputting a product traceability code, according to an embodiment of the present invention. The system comprises an initialization module 111, and a generation module 112. In actual implementation, the system is set up in a server 110, which is one of the nodes of the blockchain network 100 and has the same functions as the node 120. The initialization module 111 is configured to create a genesis block corresponding to a product (such as, a physical object such as ceramics, bags, clothes, planting product), and the initialization module 111 can use the genesis block as a header of a blockchain. The initialization module 111 also creates a smart contract stored in the genesis block, and the smart contract can comprise a uniform resource identifier (URI), a creator contact message, an owner account address, and a transaction function all corresponding to the product. Next, during a transaction for the product, the smart contract permits the blockchain node having the owner account address to call the transaction function, to further set the owner account address as a seller account address, and store the seller account address, the buyer account address, a transaction amount and a transaction time in a transaction array, and to further set the buyer account address as the owner account address. According to the creator contact message, the transaction message comprising the seller account address, the buyer account address, the transaction amount and transaction time, is transmitted for display.

In actual implementation, the creator contact message may include a communication manner for contacting the creator, for example, the creator contact message can include an email address, a telephone number, an account of communication software. The transaction message can be transmitted to the creator through the email, SMS, communication software, and so on, so as to notice the creator with the transaction and details thereof Initially, the owner account address are set as the account address (that is, the creator account address) of the creator in the blockchain network, so that the first owner account address is also the creator account address. It is to be noted that the aforementioned addresses, such as the owner account address, the seller account address, the buyer account address, the creator account address, are the addresses used in the blockchain, and each of these addresses can be generated by hash function formed with SHA-256 hash and RIPEMD-160 hash; for example, a 512-bit public key is converted into 160-bit data by the hash function, and the 160-bit data is then encoded as an address, such as “0x26b3792fd2b4cfc255d780bef419d56299df6a36”, thereby facilitating to charge or pay transaction fee.

In actual implementation, the way of creating the genesis block can use a preset genesis block definition file, such as genesis.json, to generate the genesis block corresponding to the definition file and use the generated genesis block as the header of the blockchain. Furthermore, in the genesis.json, a creator account address can be assigned to be a manager in advance, to prevent the inability to modify the smart contract afterward.

It is to be noted that the transaction array is a memory space configured to store the seller account address, the buyer account address, the transaction amount and the transaction time of all transactions read from the blockchain; in other words, the content of the transaction array can be changed during the transactions, so the content of the transaction array may be regarded as a variable. The transaction time can be directly generated by using a block time stamp.

The generation module 112 is configured to generate and output the product traceability code, according to the URI and an address of the smart contract in the blockchain. For example, to output the product traceability code to the creator by email or in other more secure and confidential ways, such as blockchain encryption, Dropbox, encrypted storage, etc. In actual implementation, the product traceability code can be presented by using a barcode or character data, such as a quick response code (QR code), or the character data written into the RFID tag. It is to be noted that the address of smart contract can be used as a parameter of the URI. For example, suppose that the URI is “www.bb.com/pro?id=1”, and the address of the smart contract on the blockchain is “0xd02b2aef052b22abf3cb74c9d95487322819ab5e”, and when the address of the smart contract is used as the parameter of the URI, the entire string can be presented as “www.bb.com/pro?id=1&addr=0xd02b2aef052b22abf3cb74c9d95487322819ab5e”, and can also be regarded as the URI. Therefore, after the product traceability code is scanned or sensed, the user can link to a webpage according to the URI, to browse the detailed illustration of the product, or transaction history of the product. Furthermore, the parameter of the smart contract can be changed by the address of the smart contract.

The system can further include a combination module 113. The combination module 113 is configured to output the product traceability code by using the output device, so that the product traceability code and the product can be integrally combined permanently, and the product traceability code is unable to be broken or post-produced. In actual implementation, the output device can be a laser engraving device, a RFID tag read-write device, a printing device and so on. In an embodiment, the output device can be the laser engraving device to carve the product traceability code to the surface of the product, so that a scan device is able to scan the product traceability code. When the output device is the RFID tag read-write device, the product traceability code can be written into a RFID tag, so that the sensing device can sense and read the product traceability code from the RFID tag. The output device can be a printing device to print the product traceability code to the rubbing paper, and after the rubbing paper is in contact with the surface of the product to rub the product traceability code on the product and the product rubbed with the product traceability code is kilned, the product traceability code can be sintered on the product, so that a scan device can scan the product traceability code.

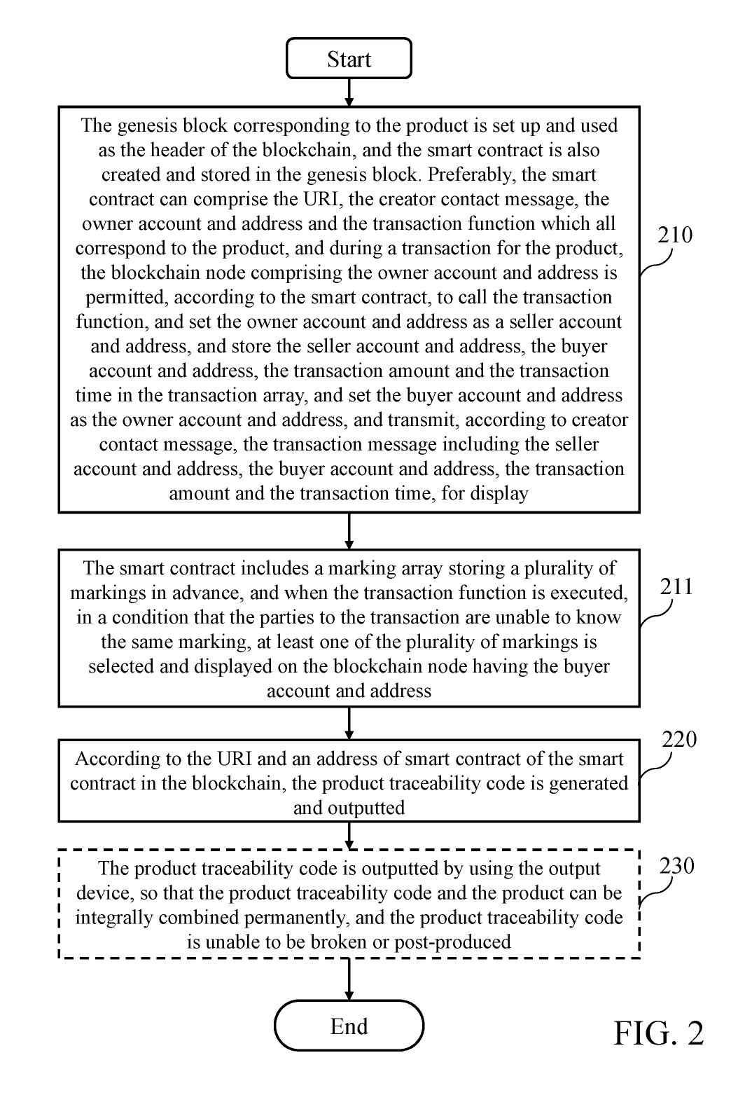

Please refer to FIG. 2, which is a flow chart of a method of outputting a product traceability code, according to an embodiment of the present invention. The method includes steps 210 to 230. In the step 210, the genesis block corresponding to the product is set up and used as the header of the blockchain, and the smart contract is also created and stored in the genesis block. Preferably, the smart contract can comprise the URI, the creator contact message, the owner account address and the transaction function which all correspond to the product, and during a transaction for the product, the blockchain node comprising the owner account address is permitted, according to the smart contract, to call the transaction function, and set the owner account address as a seller account address, and store the seller account address, the buyer account address, the transaction amount and the transaction time in the transaction array, and set the buyer account address as the owner account address, and transmit, according to creator contact message, the transaction message including the seller account address, the buyer account address, the transaction amount and the transaction time, for display. In the step 220, according to the URI and an address of smart contract of the smart contract in the blockchain, the product traceability code is generated and outputted. Through aforementioned steps, the initialization module 111 can create the non-deletable and non-modifiable storage space (such as the transaction array of the smart contract) corresponding to the product, and the generation module 112 can generate and output the product traceability code according to the URI, so that in the transaction for the product, the user can link to the corresponding storage space to store and browse the transaction message of the product, according to the URI obtained by scanning or sensing the product traceability code.

In the step 211, the smart contract created in the step 210 may include a marking array storing a plurality of markings in advance, and when the transaction function is executed, in a condition that the parties to the transaction are unable to know the same marking, at least one of the plurality of markings is selected and displayed on the blockchain node having the buyer account address. The buyer can compare the product with the received marking to identify whether the bought product is a genuine product. For example, when the received marking matches with the product, it indicates that the product is a genuine product; otherwise, when the marking does not match with the product, it indicates that the product is a counterfeit product. Then, after the step 220, the method can further include step 230. In the step 230, the product traceability code is outputted by using the output device, so that the product traceability code and the product can be integrally combined permanently, and the product traceability code is unable to be broken or post-produced.

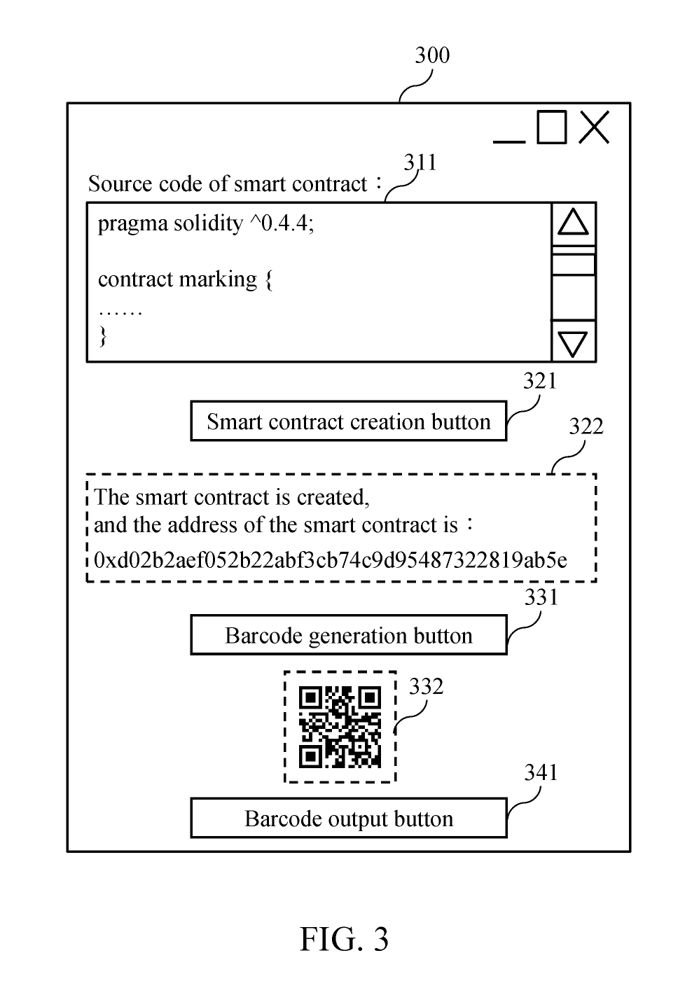

The following describes embodiments of the present invention with reference to FIGS. 3 to 7. Please refer to FIG. 3, which is a schematic view of a smart contract and a product traceability code, according to an embodiment of the present invention. In actual implementation, in order to generate the product traceability code corresponding to the product, the creator can open an operation window 300 and input a program source code of the smart contract into a smart contract editing box 311, and click a smart contract creation button 321 to create the smart contract. After the smart contract is created in the blockchain successfully, an address of the smart contract is displayed on the operation window 300, for example, the address of the smart contract can be shown in first display block 322. Next, the creator can click a barcode generation button 331 to generate and output the product traceability code, and the outputted product traceability code can be presented as a QR code, as shown in a second display block 332. Next, the creator can click a barcode output button 341, to use the output device to integrally combine the product traceability code with the product permanently, so that the product traceability code is unable to be broken or post-produced. For example, when the output device is the laser engraving device, the product traceability code can be carved to the surface of the product, so that a scan device can scan the product traceability code; when the output device is the RFID tag read-write device, the product traceability code can be written into the RFID tag, so that a sensing device can sense and read the product traceability code, for example, a plant breeder can insert the RFID tag in the stem of the plant to be bred, and after the plant grows, the RFID tag can be completely encased inside the plant and served as an unique evidence for legal protection of plant variety of this plant; furthermore, in a process of packaging food or beverages, the RFID tags can also be affixed in bottles, cans or packages to serve as unique production and sale's traceability; when the output device is the printing device, the product traceability code can be printed on packaging material, rubbing paper or screen printing cloth. For example, after the rubbing paper is in contact with the surface of the product to rub the product traceability code on the product and the product rubbed with the product traceability code is kilned, the product traceability code can be sintered on the product, so that a scan device can scan the product traceability code packaging material, rubbing paper or screen printing cloth. For example, after the rubbing paper is in contact with the surface of the product to rub the product traceability code on the product and the product rubbed with the product traceability code is kilned, the product traceability code can be sintered on the product, so that a scan device can scan the product traceability code. In other embodiment, in the manufacturing process of the product, the garment or bag manufacturer can stitch the product with the screen printing cloth having the traceability code, so that the screen printing cloth can be used as an authentication manner combining with the physical product before delivery of the product.

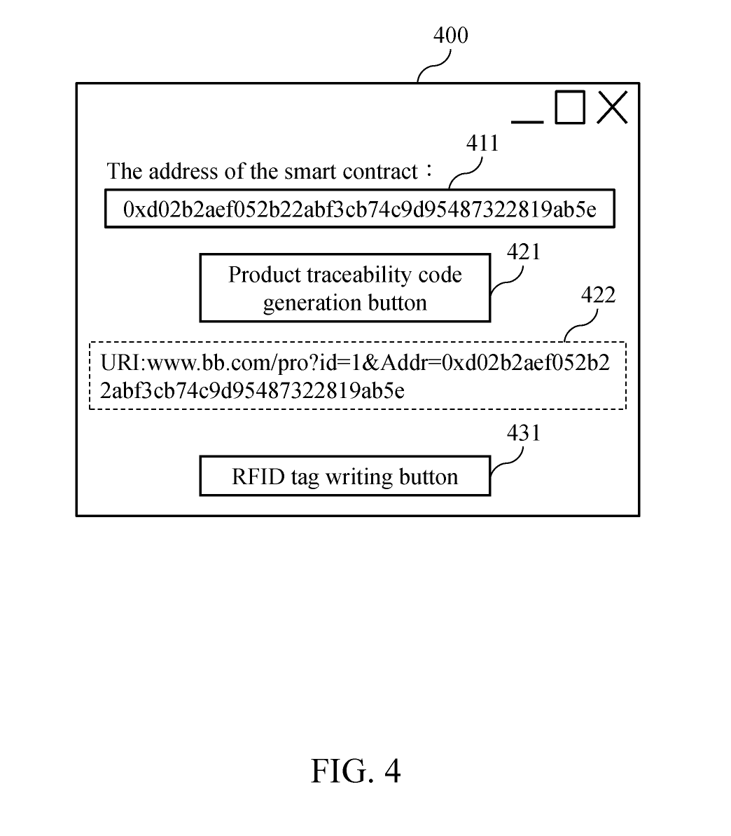

Please refer to FIG. 4, which is another schematic view of operation of generating a product traceability code, according to an embodiment of the present invention. In this embodiment, the product traceability code is presented by the QR code; however, in an actual implementation, the product traceability code can be the URI including the address of smart contract. For example, the creator can open the operation window 400, and input the address of smart contract into the input box for address of smart contract 411. Next, after the creator clicks a product traceability code generation button 421, the generated URI is displayed in the display block 422. After confirming the URI, the creator can click a RFID tag writing button 431 to write the generated URI into the RFID tag by using the output device (such as RFID tag read-write device), so that the buyer can use the sensing device to sense the URI. The buyer can use a sensing device to sense the RFID tag and read the URI, and then the sensing device or the computer device electrically connected to the sensing device can be linked to the server corresponding to the URI, through a browser. The server is one of the nodes of the blockchain network, and can provide the detailed introduction about the product through the webpage, and obtain the owner account address of the product according to the address of smart contract of the URI, and generate and display the transaction webpage, so as to facilitate the buyer to purchase, through the transaction webpage, the product from the owner.

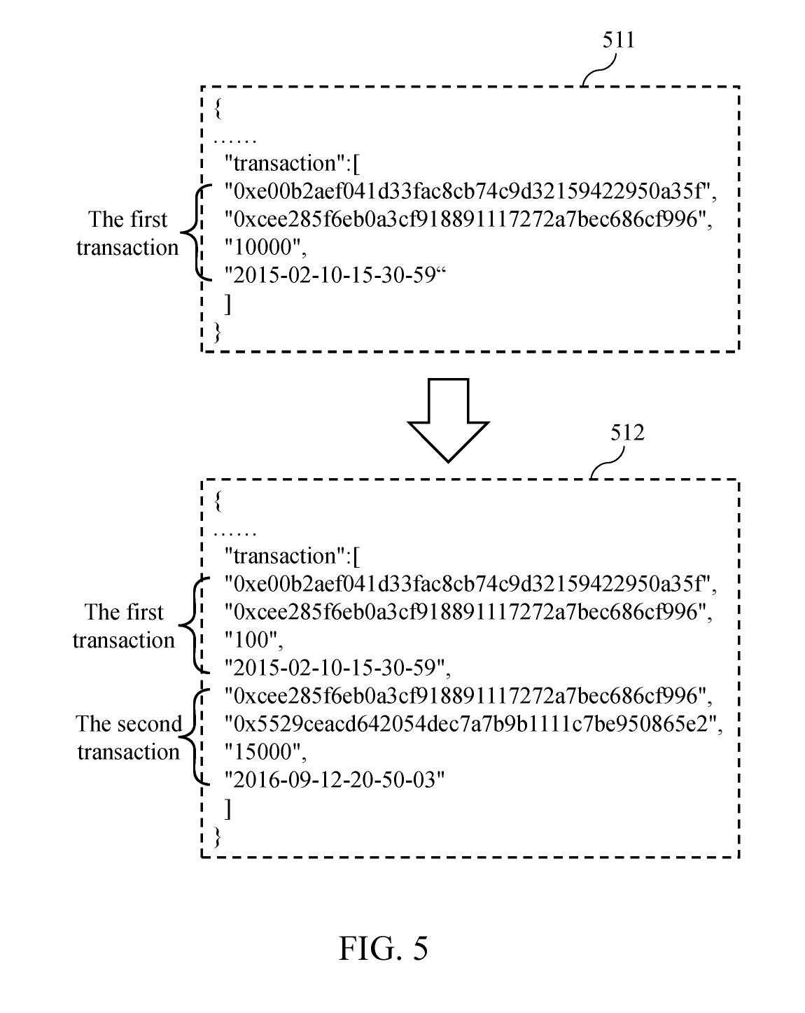

Please refer to FIG. 5, which is a schematic view of operation of storing transaction data in the transaction array, according to an embodiment of the present invention. In actual implementation, in each transaction for the product, after receiving the transaction amount, the owner of the product can use the blockchain node having the owner account address to call the transaction function of the smart contract, to set the owner account address as the seller account address, and store the seller account address, the buyer account address, the transaction amount and the transaction time in a transaction array, and set the buyer account address as the owner account address. In a case that the transaction array is taken as example for illustration, suppose that transaction array 511 before this transaction stores a piece of transaction data, and the transaction array 512 after this transaction will store two pieces of transaction data after other transaction, and so forth. Each piece of transaction data includes the seller account address, the buyer account address, the transaction amount and the transaction time. Furthermore, during each transaction for the product, the transaction message including the seller account address, the buyer account address, the transaction amount and the transaction time, can be transmitted according to the preset creator contact message, so that the creator can know the transaction and detail thereof according to the transaction message. As a result, transferring of the owner of the product is completed, the transaction data is also stored in the blockchain, and the creator of the product can also know the detail of this transaction, such as the seller account address, the buyer account address, the transaction amount and the transaction time, according to the transaction data of the blockchain; and, the later buyer can also know the transaction history clearly, and the buyer can directly ask question to the creator according to the creator contact message when the buyer account address and the owner account address of the last transaction are different. It should be noted that the seller account address, the buyer account address, the transaction amount and the transaction time all stored in the transaction array can be presented in the data format of JSON or XML.

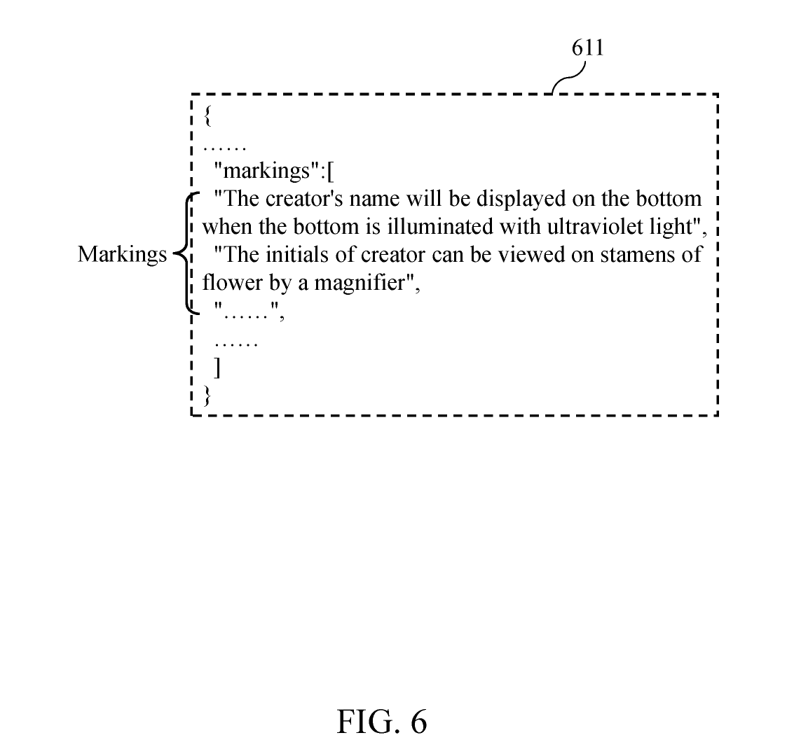

Please refer to FIG. 6, which is a schematic view of a marking array, according to an embodiment of the present invention. In actual implementation, the smart contract may include a marking array 611 storing a plurality of markings, in advance. When the transaction function is executed, in a condition that the parties to the transaction are unable to know the same marking, at least one of the plurality of markings is selected and displayed on the blockchain node having the buyer account address. Particularly, in each transaction for the product, the buyer can know one of the markings, but the buyer will become a seller (that is, an owner) in next transaction; for this reason, in order to prevent the buyer and the seller from obtaining the same marking in one transaction to cause mistrust of the buyer in the displayed marking, the markings which the buyer and seller both know are excluded in the process of selecting the markings to be displayed. As a result, the buyer can identify whether the product is authentic or fake, according to the received marking. In other words, the buyer knows the markings which the seller does not know, so the buyer can identify the product according to whether the received marking matches with the product; in the other hand, the seller is hard to know all markings of the product, so it is more difficult for the seller to produce a counterfeit product with correct markings, thereby reducing the possibility of the seller selling counterfeit product. It should be noted that the manner of displaying the marking can be presented by augmented reality, the following will describe the detail with reference to the accompanying drawings.

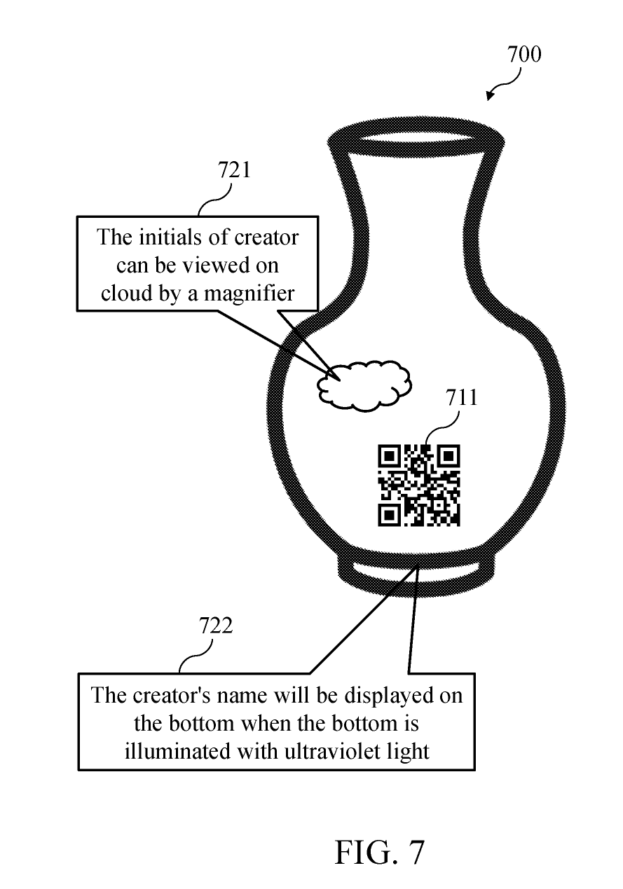

Please refer to FIG. 7, which is a schematic view of operations of displaying the marking by augmented reality, according to an embodiment of the present invention. The above-mentioned manner of displaying the marking can be presented by augmented reality. In an embodiment, the product is a vase 700 painted with cloud, and the vase 700 also has the product traceability code 711 kilned and rubbed thereon. After the buyer uses the scan device (such as an AR glass) to scan the product traceability code 711, the scan device can obtain the URI and the address of the smart contract, and then download the marking according to the obtained URI and the address of the smart contract, and the downloaded marking is displayed on AR display block 721 and 722. In this embodiment, the AR display block 721 and 722 are virtual images augmented to real environment by the augmented reality technology, and shown on the AR glass to display the marking.

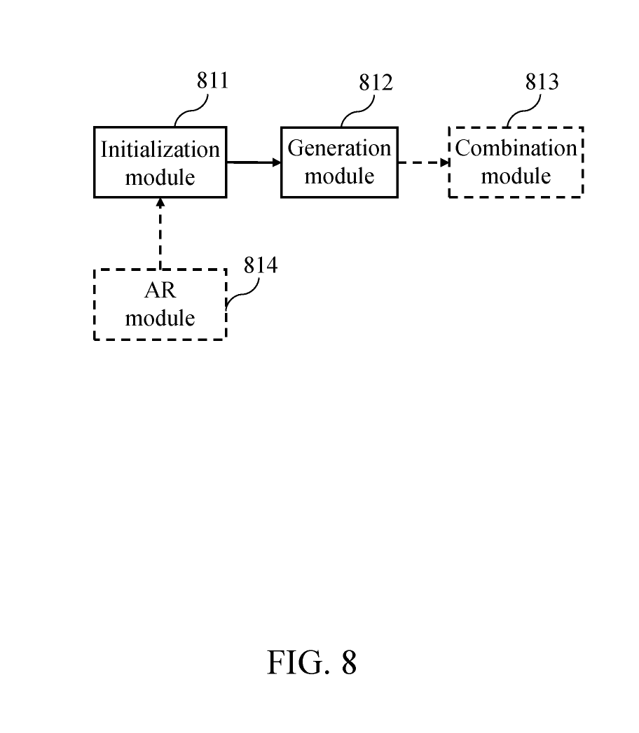

Please refer to FIG. 8, which is a block diagram of the system for outputting product traceability code, according to another embodiment of the present invention. The system includes an initialization module 811, and a generation module 812. The initialization module 811 is configured to set up the storage space corresponding to the product. The storage space is accessible, non-deletable and non-modifiable, and can store a URI, a creator contact message, an owner account and a transaction array which all are associated to the product, in advance. During the transaction for the product, an owner terminal having the owner account is permitted to set the owner account as a seller account, and store the seller account, the buyer account, the transaction amount and the transaction time as the transaction message, and store the transaction message in the transaction array, and then set the buyer account as the owner account, and according to the creator contact message, transmit the transaction message for display. In an actual implementation, the creator can use an account and a password to log in the system of the present invention for outputting product traceability code, that is, the creator logins the platform applying the technology of the present invention. After login, the creator can set up the storage space corresponding to the product, and in the storage space, the creator can create the URI, the creator contact message, the owner account and the transaction array all associated with the product, in advance. Preferably, the storage space can be a database or a file located in storage media (such as memory, hard disk, floppy disc and so on). More particularly, after the creator sets up the storage space corresponding to the product, the data written into the storage space will be in the read-only state, that is, the data becomes non-deletable and non-modifiable. Furthermore, the login account can be set as the owner account.

The generation module 812 is configured to generate the product traceability code, according to the URI. In this case, the product traceability code can be presented by barcode or character data. It should be noted that the URI can be a string for identifying certain internet network resource name used to access a resource (such as a webpage, an image, audio and video or a file) in the storage space through a specific protocol. In actual implementation, the AR marking stored in the storage space can be viewed as a resource.

The system can further include a combination module 813. The combination module 813 is configured to output the generated product traceability code and integrally combine the product traceability code with the product permanently, by using the output device, so that the product traceability code is unable to be broken or post-produced. In actual implementation, the output device can be the laser engraving device, the RFID tag read-write device, the printing device and so on. When the output device is the laser engraving device, the product traceability code can be carved to the surface of the product, so that a scan device can scan the product traceability code; when the output device is the RFID tag read-write device, the product traceability code can be written into the RFID tag, so that a sensing device can sense the product traceability code, for example, a plant breeder can insert the RFID tag in the stem of the plant to be bred, and after the plant grows, the RFID tag can be completely encased inside the plant and served as an unique evidence for legal protection of plant variety of this plant; furthermore, in a process of packaging food or beverages, the RFID tags can also be affixed in bottles, cans or packages to serve as unique production and sale's traceability; when the output device is the printing device, the product traceability code can be printed on packaging material, rubbing paper or screen printing cloth. For example, after the rubbing paper is in contact with the surface of the product to rub the product traceability code on the product and the product rubbed with the product traceability code is kilned, the product traceability code can be sintered on the product, so that a scan device (such as the AR device) can scan the product traceability code. In other embodiment, in the manufacturing process of the product, the garment or bag manufacturer can stitch the product with the screen printing cloth having the traceability code, so that the screen printing cloth can be used as an authentication manner combining with the physical product before delivery of the product.

In an embodiment, the system includes an augmented reality module 814 configured to store the AR markings corresponding to the product in the storage space, in advance. After the product traceability code is scanned or sensed, at least one of the plurality of AR markings can be selected and downloaded from the storage space, according to the URI, and the AR markings provided for the parties to the transaction are not the same. In actual implementation, the AR marking can be the marking which is hard to be reproduced even if being known by the people with bad intention, such as fluorescent splash point. The features of splash points caused by different splashing actions are not the same and hard to reproduce, so the buyer can identify whether the product is genuine or counterfeit according to the features of the splash points, after checking that the splash points are produced by a nature splash action. For example, when the sizes, shapes and distribution of the splash points, and the distances between the splash points on the product match with that received by the buyer, the buyer can determine the product to be a genuine product; otherwise, the buyer can determine the product to be a counterfeit product.

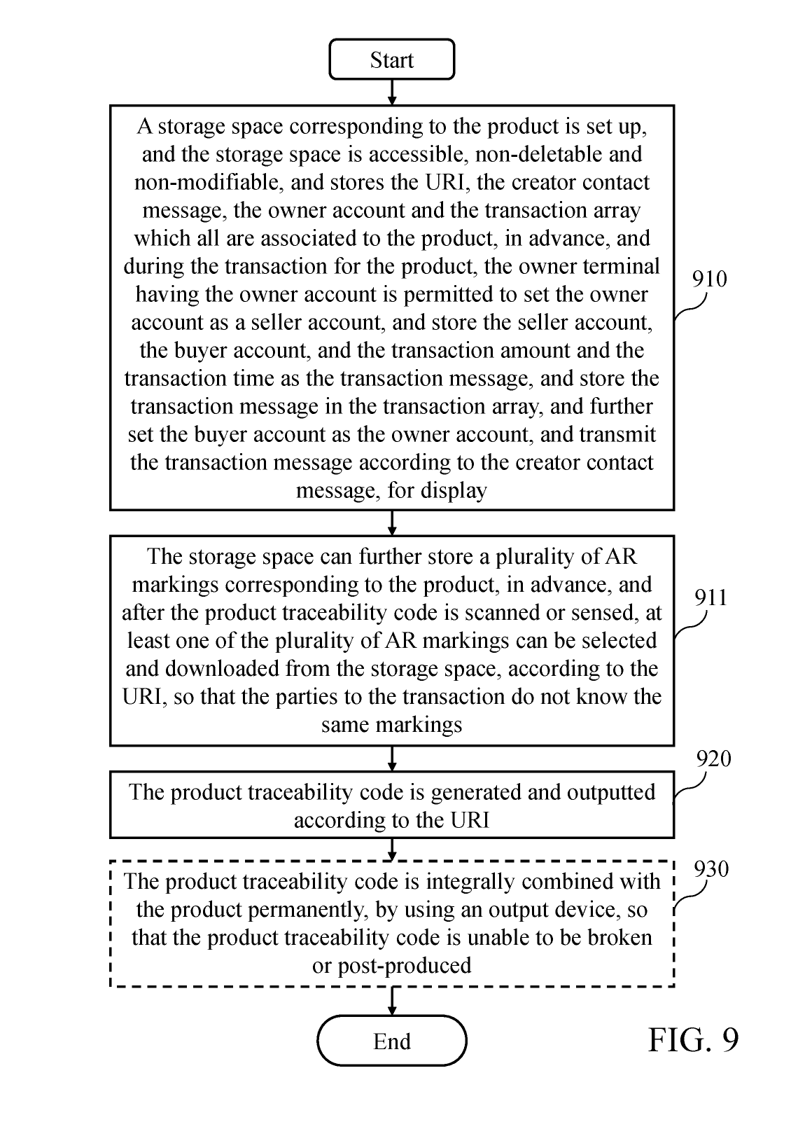

Please refer to FIG. 9, which is a flow chart of another method of outputting the product traceability code, according to an embodiment of the present invention. The method includes steps 910 and 920. In the step 910, the storage space corresponding to the product is set up, and the storage space is accessible, non-deletable and non-modifiable, and stores the URI, the creator contact message, the owner account and the transaction array which all are associated to the product, in advance. During the transaction for the product, the owner terminal having the owner account is permitted to set the owner account as a seller account, and store the seller account, the buyer account, and the transaction amount and the transaction time as the transaction message, and store the transaction message in the transaction array, and further set the buyer account as the owner account, and transmit the transaction message according to the creator contact message, for display. In the step 920, the product traceability code is generated and outputted according to the URI. After the step 920, the method can further include step 930. In the step 930, the product traceability code is integrally combined with the product permanently, by using an output device, so that the product traceability code is unable to be broken or post-produced. Through above-mentioned steps, the initialization module 811 can set up the storage space corresponding to the product, and the storage space stores the URI, the creator contact message, the owner account and the transaction array which all are associated with the product, and the generation module 812 can generate the product traceability code according to the URI, and the combination module 813 can integrally combine the product traceability code and the product permanently, by using the output device. As a result, during the transaction for the product, according to the URI obtained by scanning or sensing the product traceability code, the user can link to the storage space to store and browse the transaction message of the product.

In an embodiment, the step 910 can further include a step 911. In the step 911, the storage space can further store a plurality of AR markings corresponding to the product, in advance, and after the product traceability code is scanned or sensed, at least one of the plurality of AR markings can be selected and downloaded from the storage space, according to the URI, so that the parties to the transaction do not know the same markings, for example, the markings provided for the parties to the transaction are not the same. In an actual implementation, more AR markings and more manners of identifying the AR markings can reduce the probability of obtaining the AR markings through many false transactions. For example, identifications of some of the AR markings must use ultraviolet light, identifications of some of the AR markings must use microscope, and some of the AR markings are special patterns, images, number or text which can be viewed by a specific angle only. Furthermore, some of the AR markings can be reserved for the creator to identify the product, and are not provided to the parties to the transaction.

In actual implementation, the smart contract or the storage space can store the owner's facial features, voice features, fingerprint features or other physiological features in advance, and these physiological features can be used for face recognition, speech recognition fingerprint recognition or other physiologic recognition. For example, after the buyer scans or senses the product traceability code disposed on the product, the product traceability code can be analyzed to obtain the URI, and the buyer then can, according to the obtained URI and from the corresponding storage space, download the facial features, the voice features, the fingerprint features or other physiological features. After the facial features are downloaded, the buyer can compare the downloaded facial features with a face image provided by the seller; for example, the buyer can extract the features of the face image of the seller, and then compare the extracted features with the downloaded facial features, and when the extracted features match with the downloaded facial features, it indicates that the features of the face image are consistent with the facial features of the owner, so the buyer can confirm that the seller is the owner. In other embodiment, the voice features are downloaded, and the buyer can record the seller's speech and extract features from the speech, and compare the extracted features with the downloaded voice features, and when the extracted features match with the downloaded voice features, it indicates that the features of the seller's speech are consistent with the voice features of the owner, so the buyer can confirm that the seller is the owner. In other embodiment, the fingerprint features are downloaded, the buyer can scan the seller's fingerprint to generate a fingerprint image, and then compare the fingerprint image with the download fingerprint features; for example, the buyer can extract features of the fingerprint image, and then compare the extracted features with the downloaded fingerprint features, when the extracted features match with the downloaded fingerprint features, it indicates that the features of the seller's fingerprint image are consistent with the owner's fingerprint features, so the buyer can confirm that the seller is the owner. The manner of comparing other physiological features can be derived from above-mentioned manners. It should be noted that the facial features are features (such as, feature points) extracted from the face image; and the voice features are features extracted from the speech; and, the fingerprint features are features extracted from the fingerprint image of finger; and, the other physiological features (such as features of retina or finger vein) are generated by manners similar to above-mentioned manners. The purpose of extracting the features is to solve the problem that the size of original image file or original speech file not being processed may exceed the capacity of the storage space or may occupy too much space, and is also to protect the owner's privacy.

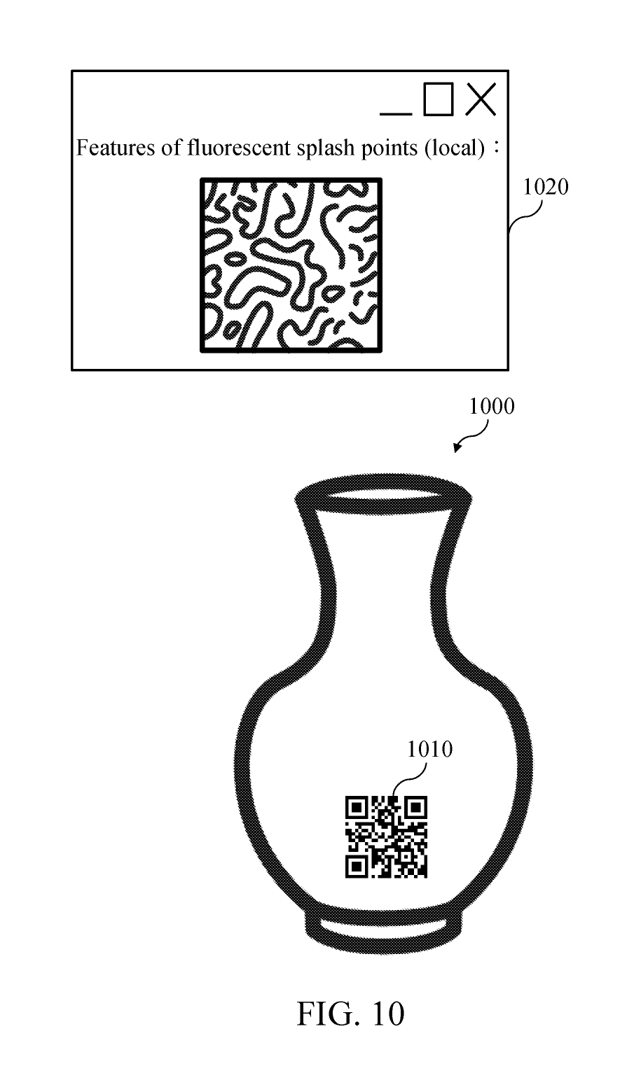

The following describes an embodiment with reference to FIG. 10, which is a schematic view of the AR marking, according to an embodiment of the present invention. The AR markings can be the markings which are hard to be reproduced even if being known by the people with bad intention, for example, the markings can be fluorescent splash points. In actual implementation, while manufacturing the product 1000, the creator can splash special pigment, which responds to specific light (such as ultraviolet light) only, on the surface of the product 1000, so as to form unique features on the surface of the product 1000 and use these features as the AR markings. During the transaction for the product, the buyer can use the AR device, such as AR glass or AR mobile device, to directly scan the product traceability code 1010 on the product 1000, so as obtain the URI, and then the AR device can, according to the URI, download the AR marking corresponding to the product 1000 from the storage space. After the camera (such as CCD or CMOS) of the AR glass is aligned with the product 1000 and the feature recognition is completed, the AR glass can display an augmented reality window 1020 by a multilayer manner. As shown in FIG. 10, local features of the fluorescent splash points are displayed in the augmented reality window 1020, so that the buyer can check whether the local features are the same as the features of the product 1000. It should be noted that the local features of the fluorescent splash points are taken as example for illustration, however, but the present invention is not limited thereto; in other embodiment, the augmented reality window 1020 can also display whole features of the fluorescent splash points for buyer to identify.

In summary, the difference between the system of the present invention and the conventional technology is that the system of the present invention can use the initialization module to set up the non-deletable and non-modifiable storage space corresponding to the product, and use the generation module to generate and output the product traceability code according to the URI, so that during the transaction for the product, the user can link to the storage space to store and browse the transaction message of the product, according to the URI obtained by scanning or sensing the product traceability code. The technical solution of the present invention can solve the conventional problem, and achieve the technical effect of improving authentic and fake recognition and transaction transparency of the product.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A system for outputting product traceability code, comprising:
an initialization module configured to create a genesis block corresponding to a product, and use the genesis block as a header of a blockchain and create a smart contract in the genesis block, wherein the smart contract comprises a uniform resource identifier (URI), a creator contact message, an owner account address, and a transaction function all corresponding to the product, and during a transaction for the product, a blockchain node comprising the owner account address is permitted, according to the smart contract, to call the transaction function to set the owner account address as a seller account address, and stores the seller account address, the buyer account address, a transaction amount and a transaction time in a transaction array, and to set the buyer account address as the o account address, and according to the creator contact message, transmit a transaction message comprising the seller account address, the buyer account address, the transaction amount and the transaction time, for display; and
a generation module configured to generate and output a product traceability code, according to the URI and an address of the smart contract in the blockchain.

2. The system according to claim 1, further comprising a combination module configured to output and integrally combine the product traceability code with the product permanently, by using an output device, so that the product traceability code on the product is unable to be broken or post-produced.

3. The system according to claim 1, wherein the smart contract comprises a marking array storing a plurality of markings, and when the transaction function is executed and in a condition that the parties to the transaction are unable to know the same markings, at least one of the plurality of markings is selected and displayed on the blockchain node having the buyer account address.

4. The system according to claim 2, wherein the output device can be a laser engraving device configured to carve the product traceability code on the surface of the product, so that a scan device is able to scan the product traceability code.

5. The system according to claim 2, wherein the output device can be a RFID tag read-write device configured to write the product traceability code into a RFID tag, so that a sensing device is able to sense the product traceability code.

6. The system according to claim 2, wherein the output device can be a printing device configured to print the product traceability code to the rubbing paper, and after the rubbing paper is in contact with the surface of the product to rub the product traceability code on the product and the product rubbed with the product traceability code is kilned, the product traceability code is sintered on the product, so that a scan device is able to scan the product traceability code.

7. A system for outputting a product traceability code, comprising:
an initialization module configured to set up a storage space corresponding to a product, wherein the storage space is accessible, non-deletable and non-modifiable, and configured to store a URI, a creator contact message, an owner account and a transaction array all associated to the product, and wherein during the transaction for the product, an owner terminal having the owner account is permitted to set the owner account as a seller account, and set the seller account, the buyer account, a transaction amount and a transaction time as a transaction message, and store the transaction message in the transaction array, and set the buyer account as the owner account, and transmit the transaction message according to the creator contact message, for display; and
a generation module configured to generate and output a product traceability code, according to the URI.

8. The system according to claim 7, further comprising a combination module configured to output and integrally combine the product traceability code with the product permanently, by using an output device, so that the product traceability code is unable to be broken or post-produced.

9. The system according to claim 7, further comprising an augmented reality module configured to store a plurality of AR markings corresponding to the product in the storage space, in advance, and after the product traceability code is scanned or sensed, at least one of the plurality of AR markings is select and download from the storage space according to the URI, and the parties to the transaction are unable to know the same AR markings.

10. The system according to claim 8, wherein the output device is a laser engraving device configured to engrave the product traceability code on a surface of the product, so that a scan device is able to scan the product traceability code.

11. The system according to claim 8, wherein the output device is a RFID tag read-write device configured to write the product traceability code into a RFID tag, so that a sensing device is able to sense the product traceability code.

12. The system according to claim 8, wherein the output device is a printing device configured to print the product traceability code to the rubbing paper, and after the rubbing paper is in contact with the surface of the product to rub the product traceability code on the product and the product rubbed with the product traceability code is kilned, the product traceability code is sintered on the product, so that a scan device is able to scan the product traceability code.
